(19) United States
(12) Patent Application Publication
(10) Pub. No.: US 2013/0085988 A1
(43) Pub. Date: Apr. 4, 2013

(54) RECORDING MEDIUM, NODE, AND DISTRIBUTED DATABASE SYSTEM

(71) Applicants: Tomohiko HIRAGUCHI, Kawasaki (JP); Nobuyuki Takebe, Numazu (JP)

(72) Inventors: Tomohiko HIRAGUCHI, Kawasaki (JP); Nobuyuki Takebe, Numazu (JP)

(73) Assignee: FUJITSU LIMITED, Kawasaki-shi (JP)

(21) Appl. No.: 13/614,632

(22) Filed: Sep. 13, 2012

(30) Foreign Application Priority Data
Sep. 29, 2011 (JP) 2011-215290

(51) Int. Cl. G06F 17/30

(52) U.S. Cl. 707/609; 707/703; 707/E17.005

(57) ABSTRACT

A non-transitory computer-readable recording medium for recording a data management program to cause a computer to execute a process, the process comprising, within a prescribed time period after a record stored in another computer is updated, storing the updated record so that the record before the updating and the updated record are stored in a storage unit, and by a point in time at which the prescribed time period has passed from a second point in time that is a point in time from which the prescribed time period has passed from a first point in time, receiving a reference request for the updated record, and when a transaction to perform the updating in the another computer is present at the first point in time, transmitting the record before the updating that is stored in the storage unit to a requestor of the reference request.

### CROSS-REFERENCE TO RELATED APPLICATION

This application is based upon and claims the benefit of priority of the prior Japanese Patent Application No. 2011-215290, filed on Sep. 29, 2011, the entire contents of which are incorporated herein by reference.

### FIELD

The embodiments discussed herein are related to recording media, nodes, and distributed database systems.

### BACKGROUND

When a need for referring to data in a database arises, it is necessary consistent data be referred to.

The consistent data (also referred to as atomic data) can be either a set of data before a given transaction performs updating or a set of data after a transaction commit is performed.

Here, examples of consistent data are explained.

FIG. 1A is a diagram illustrating transaction execution time.

FIG. 1B is a diagram illustrating data to be referred to.

In FIG. 1A, time is on the horizontal axis, and the execution time periods of each of transactions T1 through T5 are represented.

The transactions T1 through T4 update records R1 through R4, respectively. Committing a record makes the updating of the record definitive.

The transaction T1 commits the record R1 at a point in time t_T1_{—}a.

The transaction T2 starts the transaction at a point in time t_T2_{—}b, and commits the record R2 at a point in time t_T2_{—}a.

The transaction T3 commits the record R3 at a point in time t_T3_{—}a.

The transaction T4 starts the transaction at a point in time t_T4_{—}b, and commits the record R4 at a point in time t_T4_{—}a.

It should be noted that the points in time t_T1_{—}a, t_T2_{—}b, t_T3_{—}a, and t_T4_{—}b are before the point in time t and the points in time t_T2_{—}a and t_T4_{—}a are after the point in time t.

In FIG. 1A, consistent data (i.e., records R1 through R4) to which the transaction T5 refers to at the point in time t is either (1) or (2) of the following.

(1) data updated in the transaction T1 and T3 (data at the point in time t_T1_{—}a or t_T3_{—}a), and data before being updated in the transaction T2 and T4 (data at the point in time t_T2_{—}b or t_T4_{—}b).

(2) data updated in the transaction T1 and T3 (data at the point in time t_T1_{—}a or t_T3_{—}a), and data after being updated in the transaction T2 and T4 (data at the point in time t_T2_{—}a or t_T4_{—}a). When the data set (2) is referred to, it is necessary to wait for the transaction T2 and T4 to commit, and the data is referred to after being committed in the transaction T2 and T4.

FIG. 1B illustrates the data set (1). In other words, the records R1 through R4 to which the transaction T5 refers to at the point in time t are values at the points in time t_T1_{—}a, t_T2_{—}b, t_T3_{—}a, and t_T4_{—}b, respectively. More specifically, the records R1 through R4 to which the transaction T5 refers at the point in time t are committed data at the point in time t.

In the case of the data set (2), the records R1 and R3 are the same as the data set (1), but the records R2 and R4 are records R2′ and R4′ after the committing is performed. In other words, the records R2 and R4 are the values at the points in time t_T2_{—}a and t_T4_{—}a, respectively.

At present, distributed databases are used in the database technology to improve scalability and availability.

A distributed database is a technology of distributing and placing data in plural nodes that are connected to a network so that plural databases having plural nodes appear as if they are a single database.

In a distributed database, data is distributed into plural nodes. Each of the nodes has a cache to store data that the node handles. Each node may also store data that another node handles in the cache.

The data stored in the cache is referred to as cache data.

In addition, there is a technology related to a distributed database in which plural nodes accept referring and updating.

FIG. 2A is a diagram illustrating data updating in plural nodes.

FIG. 2B is a diagram illustrating data in the plural nodes that a transaction B refers to.

It should be noted that in the following descriptions and drawings, transactions may be denoted as tran.

A node 1005 has a cache 1006, and the cache 1006 stores records R1 and R2.

A node 1015 has a cache 1016, and the cache 1016 stores records R1 and R2.

The values of the records R1 and R2 at the time at which the transaction A starts are R1_{—}a and R2_{—}a, respectively.

In FIG. 2A, two transactions A and B are executed. The transaction A is for updating data and the transaction B is for referring to data.

Details of the processing in the transaction A are:

(1) starting the transaction
(2) updating the record R1 to R1_{—}b (UPDATE R1→R1_{—}b)
(3) updating the record R2 to R2_{—}b (UPDATE R2→R2_{—}b) and
(4) committing.
The processing in the above (1) through (4) is executed at ten o′clock, 10:10, 10:20, and 10:30, respectively.

During the transaction A, the updating of the records R1 and R2 is performed in the node 1005.

When the transaction A is started, the node 1005 updates the record R1 from R1_{—}a to R1_{—}b. The node 1005 transmits the value R1_{—}b of the updated record R1 to the node 1015 (log shipping). The node 1005 updates the record R2 from R2_{—}a to R2_{—}b. The node 1005 transmits the value R2_{—}b of the updated record R2 to the node 1015 (log shipping).

The node 1005 commits the transaction A.

Afterwards, the node 1005 transmits a commit instruction to the node 1015 and the node 1015 that received the commit instruction commits the records R1 and R2. As a result, the record R1 is updated from R1_{—}a to R1_{—}b and the record R2 is updated from R2_{—}a to R2_{—}b in the node 1015.

The data in the node 1015 is updated out of synchronization with the updating processing in the node 1005.

Details of the processing in the transaction B are:

(1) starting the transaction
(2) referring to record R1 (SELECT R1)
(3) referring to record R2 (SELECT R2)
(4) committing.
The transaction B is executed in the node 1015.

When the records R1 and R2 are referred to during the transaction B, the data referred to at specific referring times is provided in FIG. 2B.

When the records R1 and R2 are referred to before the transaction A is started, for example at 9:50, the values of the records R1 and R2 are R1_{—}a and R2_{—}a, respectively.

When the records R1 and R2 are referred to during the execution of the transaction A, for example at 10:15, the values of the records R1 and R2 have not been committed and are therefore R1_{—}a and R2_{—}a, respectively. It should be noted that Multiversion Concurrency Control (MVCC) is implemented in the node.

When the records R1 and R2 are referred to after the transaction A commits, for example at 10:40, the values of the records R1 and R2 are R1_{—}a and R2_{—}a, respectively, if the commit has not been executed in the node 1015. The values of the records R1 and R2 become R1_{—}b and R2_{—}b, respectively, if the commit has been executed in the node 1015.

FIG. 3A is a diagram illustrating data updating when a conventional updating of plural nodes (multisite updating) is performed.

FIG. 3B is a diagram illustrating data to be referred to in the transaction B when the conventional multisite updating is performed.

Anode 1007 has a cache 1008, and the cache 1008 stores the records R1 and R2.

Anode 1017 has a cache 1018, and the cache 1018 stores the records R1 and R2.

The values of the records R1 and R2 at the time at which the transaction A is started are R1_{—}a and R2_{—}a, respectively.

In FIG. 3A, two transactions A and B are executed. The transaction A is for updating data and the transaction B is for referring to data.

Details of the processing in the transaction A are:

(1) starting the transaction
(2) updating the record R1 to R1_{—}b (UPDATE R1→R1_{—}b)
(3) updating the record R2 to R2_{—}b (UPDATE R2→R2_{—}b) and
(4) committing.
The processing in the above (1) through (4) is executed at ten o′clock, 10:10, 10:20, and 10:30, respectively. During the transaction A, the updating of the records R1 is performed in the node 1007, and the updating of the record R2 is performed in the node 1017.

When the transaction A is started, the node 1007 updates the record R1 from R1_{—}a to R1_{—}b. The node 1007 transmits the value R1_{—}b of the updated record R1 to the node 1017 (log shipping).

The node 1017 updates the record R2 from R2_{—}a to R2_{—}b. The node 1017 transmits the value R2_{—}b of the updated record R2 to the node 1007 (log shipping).

The nodes 1007 and 1017 commit the transaction A.

Afterwards, the node 1007 transmits a commit instruction to the node 1017 and the node 1017 that received the commit instruction commits the record R1. As a result, the record R1 in the node 1017 is updated to R1_{—}b. The node 1017 also transmits a commit instruction to the node 1007, and the node 1007 that received the commit instruction commits the record R2. As a result the record R2 in the node 1007 is updated to R2_{—}b.

Details of the processing in the transaction B are:

(1) starting the transaction
(2) referring to record R1 (SELECT R1)
(3) referring to record R2 (SELECT R2)
(4) committing.
The transaction B is executed in the node 1017.

When the records R1 and R2 are referred to during the transaction B, the data referred to at specific referring times is provided in FIG. 3B.

When the records R1 and R2 are referred to before the transaction A is started, for example at 9:50, the values of the records R1 and R2 are R1_{—}a and R2_{—}a, respectively.

When the records R1 and R2 are referred to during the execution of the transaction A, for example at 10:15, the values of the records R1 and R2 have not been committed and are therefore R1_{—}a and R2_{—}a, respectively. It should be noted that Multiversion Concurrency Control (MVCC) is implemented in the node.

When the records R1 and R2 are referred to after the transaction A is committed, for example at 10:40, the values of the records R1 and R2 are R1_{—}a and R2_{—}b, respectively, if the commit has not been executed in the node 1017. The values of the records R1 and R2 become R1_{—}b and R2_{—}b, respectively, if the commit has been executed in the node 1017.

In other words, if the record R1 is not committed in the node 1017, the values of the records R1 and R2 are R1_{—}a and R2_{—}b, respectively, and data referred to will not be consistent.

As described above, when the multisite updating is performed in such a manner as the asynchronous cache data updating, there is sometimes a case in which consistent data cannot be referred to.

### Patent Document

### [Patent Document 1] Japanese Patent No. 4362839

### [Patent Document 2] Japanese Laid-open Patent Publication No. 2006-235736

### [Patent Document 3] Japanese Laid-open Patent Publication No. 07-262065

### Non-Patent Document

[Non-Patent Document 1] MySQL: MySQL no replication no tokucyo (Characteristics of replication of MySQL), [retrieved on Apr. 21, 2011], the Internet, <URL:http://www.irori.org/doc/mysql-rep.html>
[Non-Patent Document 2] Symfoware Active DB Guard: Dokuji no log shipping gijyutu (Unique log shipping technology), [retrieved on Apr. 21, 2011], the Internet, <URL:http://software.fujitsu.com/jp/symfoware/catalog/pdf/c z3108.pdf>
[Non-Patent Document 3] Linkexpress Transactional Replication option: Chikuji sabun renkei houshiki (sequential difference linkage system), [retrieved on Apr. 21, 2011], the Internet, <URL:http://software.fujitsu.com/jp/manual/manualfiles/M080 000/J2X16100/022200/lxtro01/lxtro004.html>

### SUMMARY

According to an aspect of the invention, a node comprises a cache and a processor.

The cache stores at least a portion of cache data stored in anther node, a first transaction list indicating a list of transactions executed in a distributed database system, and a first point in time indicating a point in time at which a request for the first transaction list is received by a transaction manager device.

The processor, when a reference request of records of a plurality of generations included in the cache data is received, receives and stores in the cache a second transaction list and a second point in time indicating a point in time at which the transaction manager device received a request for the second transaction list. The processor compares the first point in time with the second point in time, and select either the first transaction list or the second transaction list as a third transaction list by using a result of the comparing, and identifies a record of a generation to be referred to from among the records of the plurality of generations by using the third transaction list.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1A is a diagram illustrating transaction execution time.

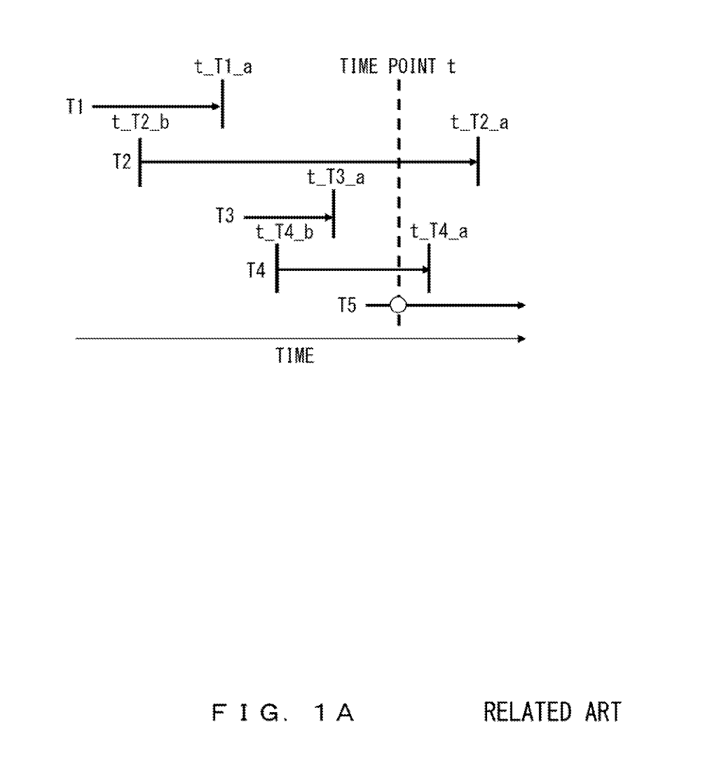

FIG. 1B is a diagram illustrating data to be referred to.

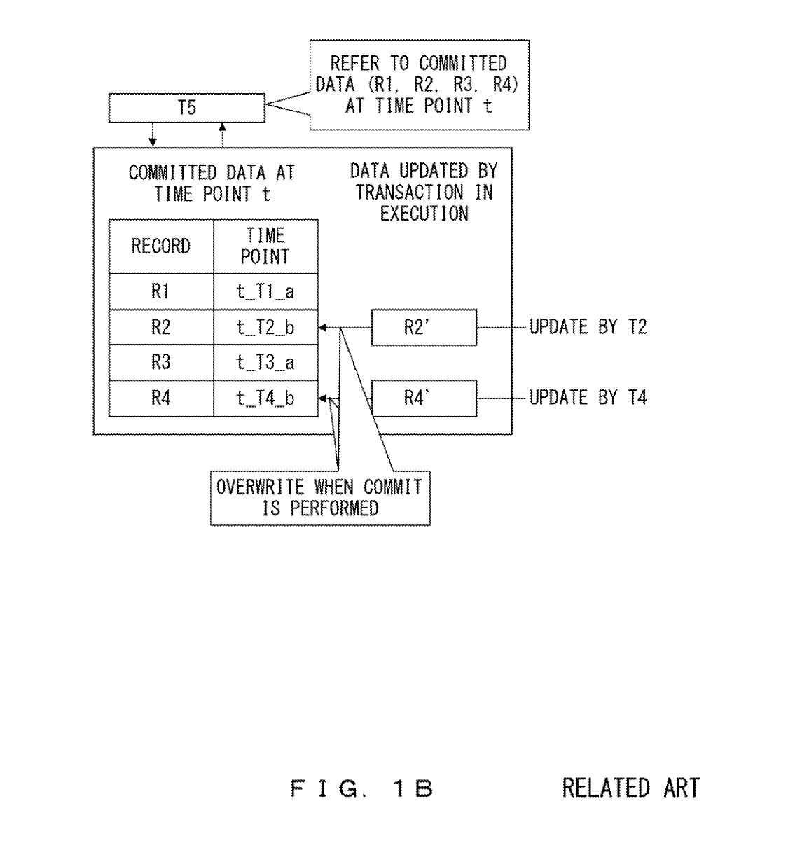

FIG. 2A is a diagram illustrating data updating in plural nodes.

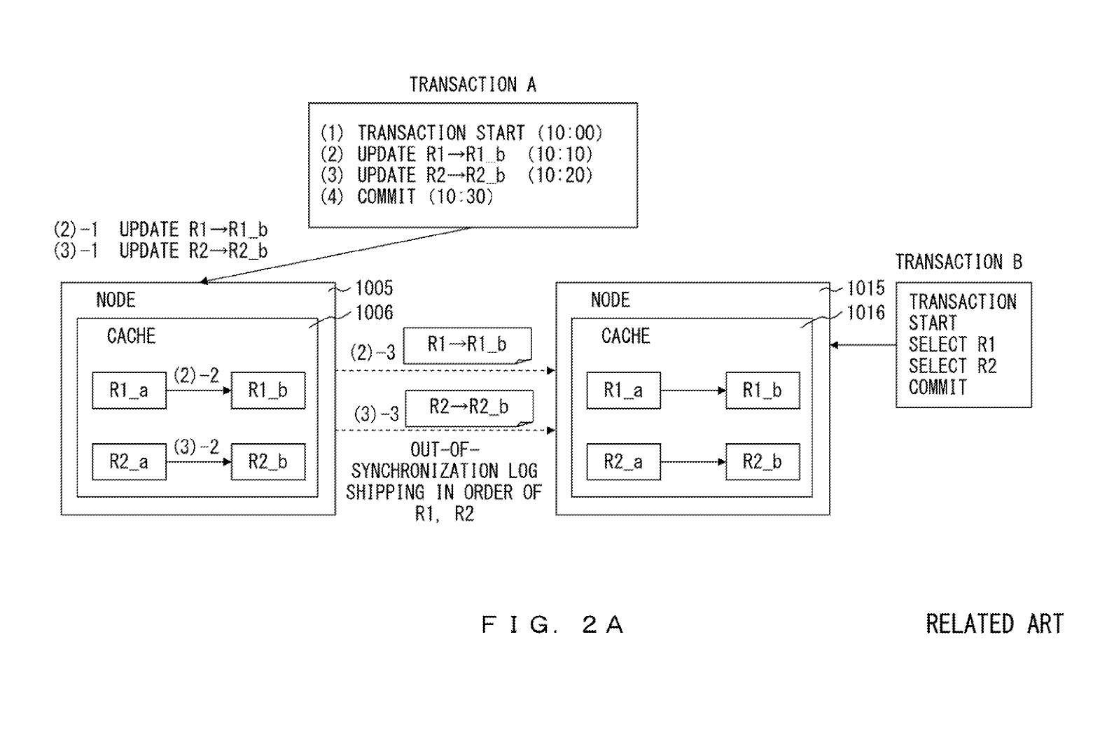

FIG. 2B is a diagram illustrating data in the plural nodes that a transaction B refers to.

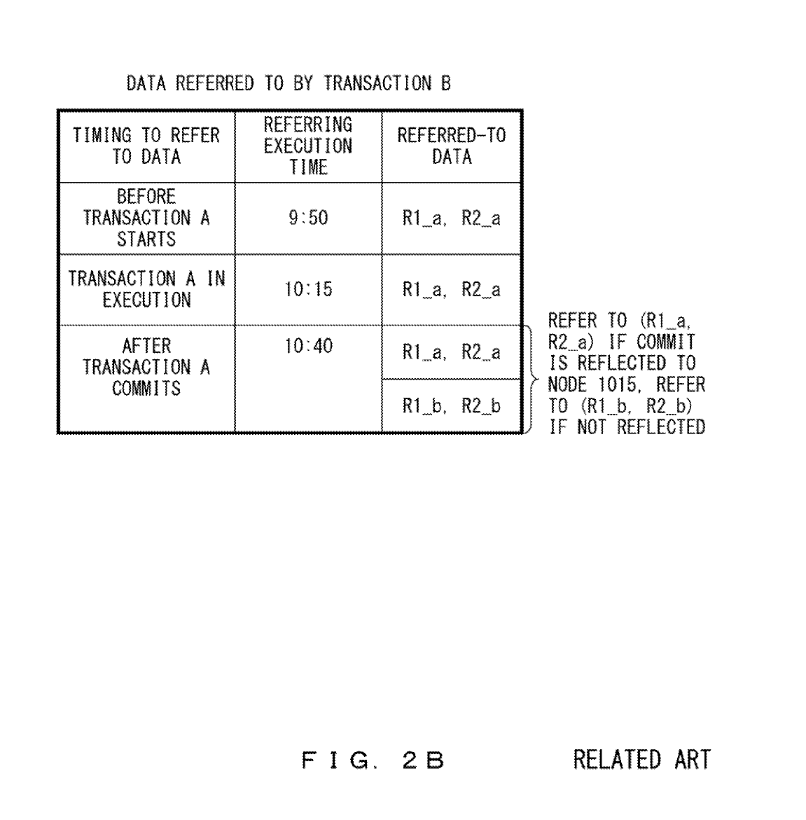

FIG. 3A is a diagram illustrating data updating when a conventional updating of plural nodes (multisite updating) is performed.

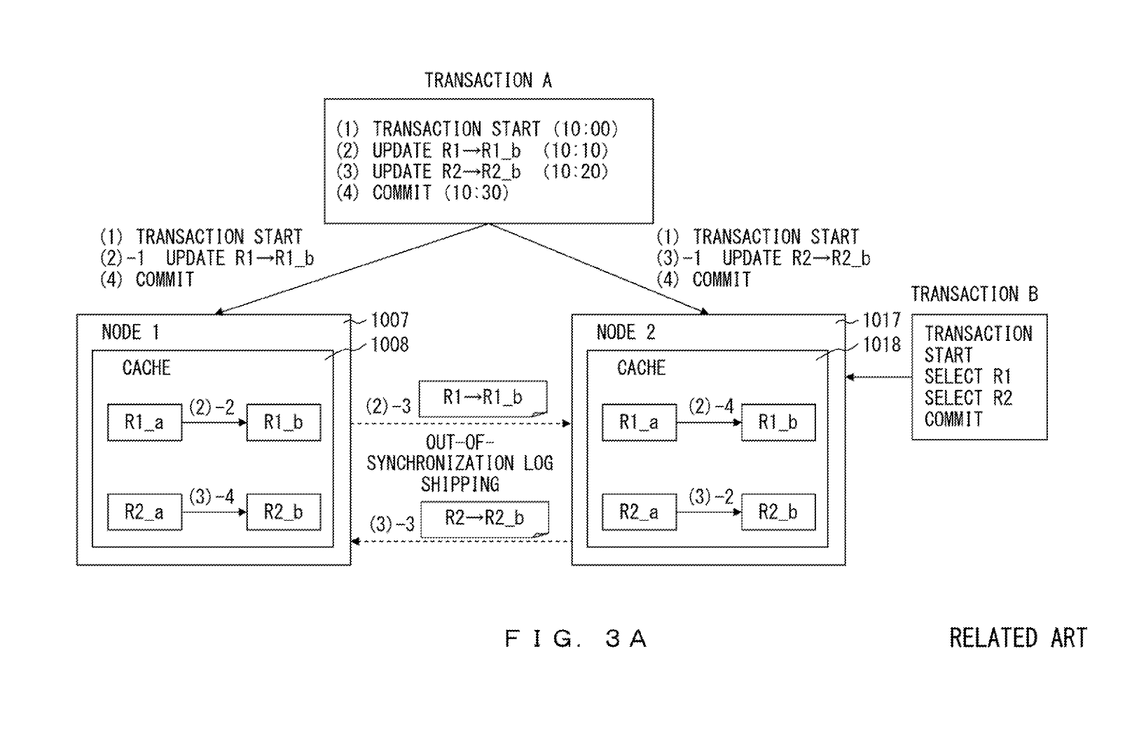

FIG. 3B is a diagram illustrating data to be referred to in the transaction B when the conventional multisite updating is performed.

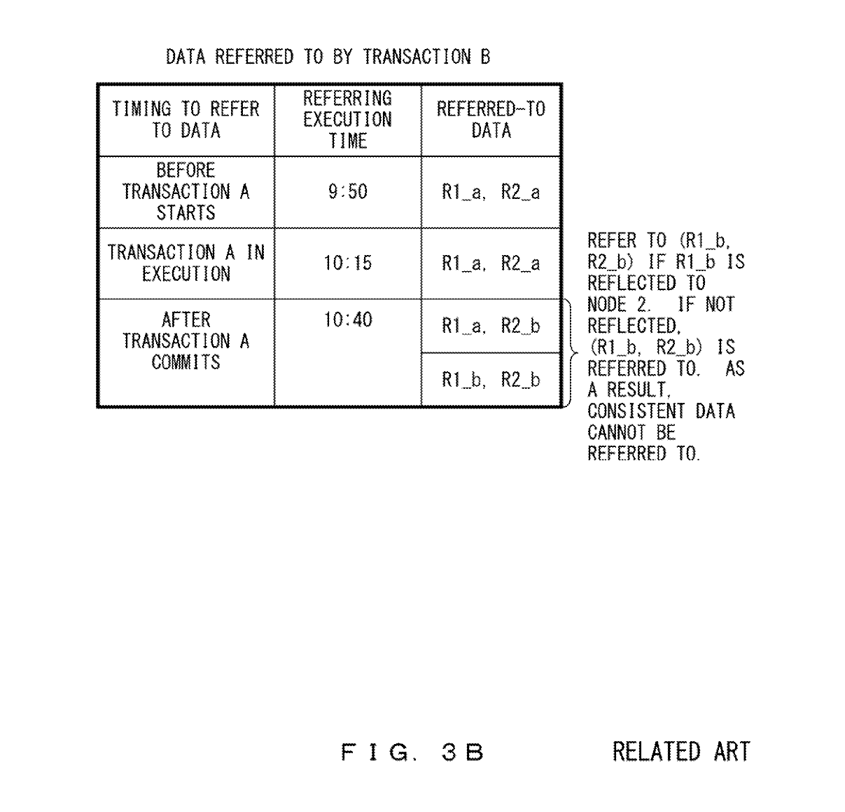

FIG. 4 is a diagram illustrating a configuration of a distributed database system according to an embodiment.

FIG. 5 is a diagram illustrating a detailed configuration of the nodes according to the embodiments.

FIG. 6 is a diagram illustrating a configuration of the cache.

FIG. 7 is a diagram illustrating the detailed structure of a page.

FIG. 8 is a diagram illustrating the structure of a record.

FIG. 9 is a diagram illustrating the configuration of the transaction manager device according to the embodiment.

FIG. 10 is a diagram illustrating updating of cache data according to the embodiment.

FIG. 11 is a flowchart of cache data update processing according to the present embodiment.

FIG. 12 is a diagram explaining data consistency according to the present embodiment.

FIG. 13 is a flowchart of snapshot selection processing according to the embodiment.

FIG. 14 is a flowchart of identification processing of a referred-to record according to the embodiment.

FIG. 15 illustrates a case in which the satisfy processing is performed on a record.

FIG. 16 is a diagram illustrating a configuration of an information processing device (computer).

### DESCRIPTION OF EMBODIMENT(S)

In the following description, embodiments are explained with reference to the drawings.

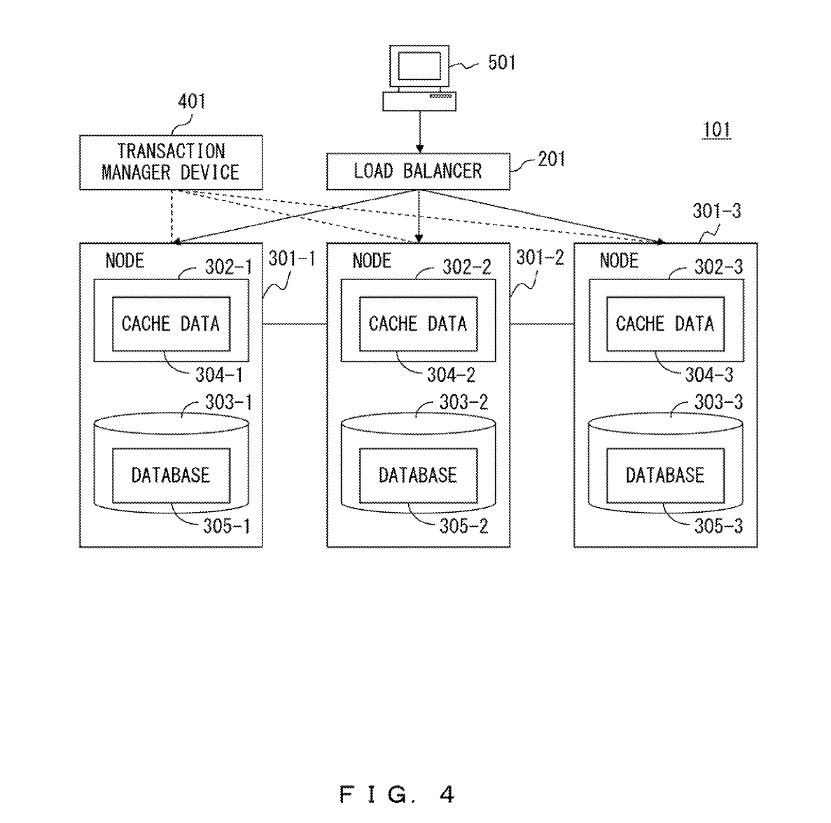

FIG. 4 is a diagram illustrating a configuration of a distributed database system according to an embodiment.

A distributed database system 101 includes a load balancer 201, plural nodes 301-i (i=1 to 3), and a transaction manager device 401. Note that the nodes 301-1 to 301-3 may be described as nodes 1 to 3, respectively.

The load balancer 201 connects to a client terminal 501 and sorts requests from the client terminal 501 into any of the nodes 301 so that the requests are sorted evenly among the nodes 301. Note that the load balancer 201 is connected to the nodes 301 via serial buses, for example.

The node 301-i includes a cache 302-i and a storage unit 303-i.

The cache 302-i has cache data 304-i.

The cache data 304-i holds data that has the same content as the content in a database 305-i in the node 301-i. In addition, the cache data includes a portion of or all of the data that has the same content as the content in a database 305 in other nodes.

For example, the cache data 304-1 has the same content as the content in the database 305-1. In addition, the cache data 304-1 has a portion or all of the database 305-2 and of the database 305-3.

Of the cache data 304, data handled by a local node to which the cache data belongs is updated in synchronization with the updating of the database in the local nodes to which the cache data belongs. In other words, data in the cache data 304 handled in the local node to which the cache data belongs is the latest data.

Of the cache data 304, data handled by other nodes is updated out of synchronization with the updating of the database in other nodes to which the cache data belongs. In other words, data in the cache data 304 handled in other nodes may not be the latest data.

The storage unit 303-i has a database 305-i.

When data requested from the client terminal 501 is not present in the cache data 304 in one of the nodes 301, the node transmits a request to other nodes 301, obtains the data from another one of the nodes 301 that holds the data, and stores the data as cache data 304.

The transaction manager device 401 controls transactions executed in the distributed database system 101. It should be noted that the transaction manager device 401 is connected to the nodes 301 via serial buses, for example.

In the distributed database system 101, updating of the database 305 is performed in plural nodes. In other words, the distributed database system 101 performs multisite updating.

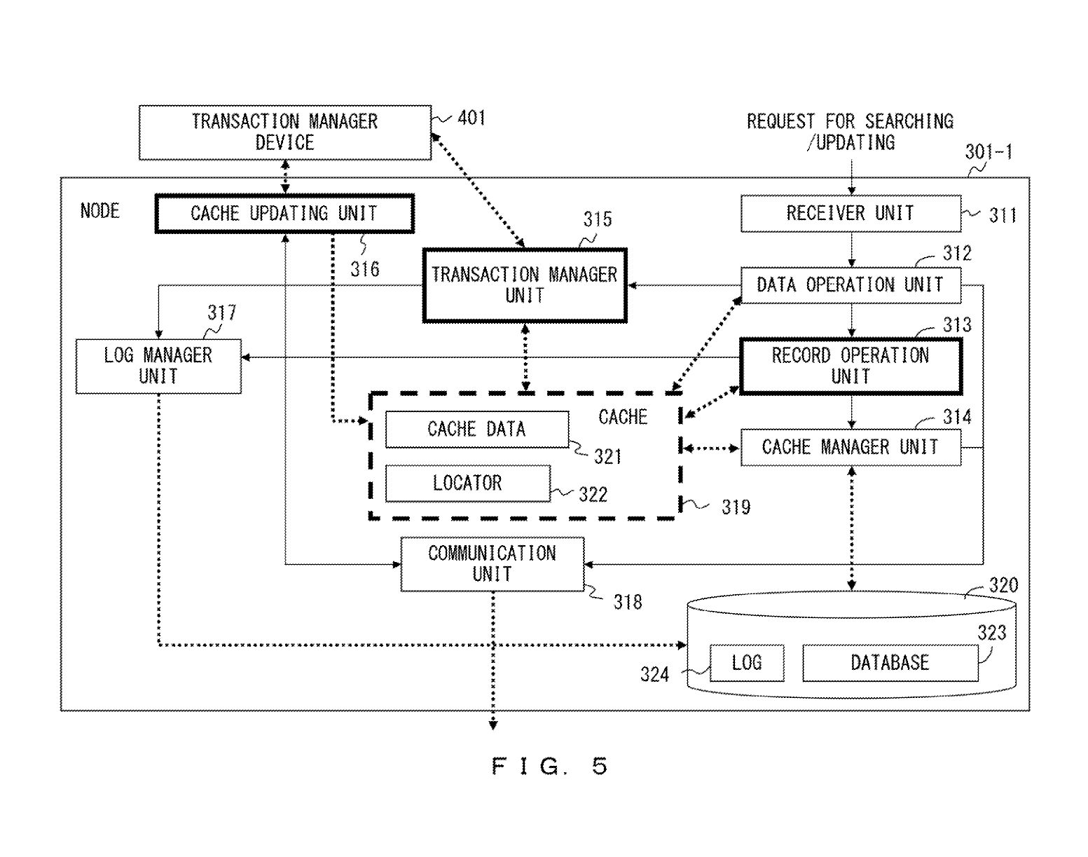

FIG. 5 is a diagram illustrating a detailed configuration of the nodes according to the embodiments.

FIG. 5 describes a detailed configuration diagram of the node 301-1. Note that although the data held in the nodes 301-2 and 301-3 are different, the configurations of those nodes are the same as that of the node 301-1, and therefore the explanation is omitted.

The node 301-1 includes a receiver unit 311, a data operation unit 312, a record operation unit 313, a cache manager unit 314, a transaction manager unit 315, a cache updating unit 316, a log manager unit 317, a communication unit 318, a cache 319, and a storage unit 320.

It should be noted that the cache 319 and the storage unit 320 correspond to the cache 302-1 and the stogie unit 303-1, respectively, of FIG. 4.

The receiver unit 311 receives database operations such as referencing, updating, and starting/ending of transactions.

The data operation unit 312 interprets and executes data operation commands received by the receiver unit 311 by referencing the information defined at the time of creating the database.

The data operation unit 312 instructs the transaction manager unit 315 to start and end a transaction.

The data operation unit 312 determines how to access the database by referencing the data operation command received by the receiver unit 311 and the definition information.

The data operation unit 312 calls the record operation unit 313 and executes a data search or updating. Since a new generation record is generated in each update for the records in the database, the record operation unit 313 is notified of what point in time the data was committed (e.g., transaction start time or data operation command execution time) is to be searched at the time of searching for data. In addition, at the time of updating data, if the local node handles the update data as a result of referring to a locator 322 that manages information of which node handles each piece of data, an update request is made to the record operation unit 313 of the local node. If the local node does not handle the update data, the update data is transferred to a node handling the update data through the communication unit 318 and the update request is made.

The record operation unit 313 performs database searching and updating, transaction termination, and log collection. In MVCC, new generation records are generated in each updating of the records in the database 323 and the cache data 321. Because resources are not occupied (exclusively) at the time of referring to the records, even if the referring processing conflicts with the update processing, the referring processing can be carried out without waiting for an exclusive lock release.

The cache manager unit 314 returns from the cache data 321 the data required by the record operation unit 313 at the time of referring to the data. When there is no data, the cache manager unit 314 identifies a node handling the data by referring to the locator 322, and obtains the latest data from the node handling the data and returns the latest data.

The cache manager unit 314 periodically deletes old generation records that are no longer referred to so as to make the old generation records reusable in order to prevent the cache data 321 from bloating. In addition, when the cache 319 runs out of free space, the cache manager unit 314 also writes data in the database 323 to free up space in the cache 319.

The transaction manager unit 315 manages the transactions. The transaction manager unit 315 requests that the log manager unit 317 write a commit log when the transaction commits. The transaction manager unit 315 also invalidates the result updated in a transaction when the transaction undergoes rollback.

The transaction manager unit 315 requests that the transaction manager device 401 obtain a point in time (transaction ID) and a snapshot at the time of starting a transaction or at the time of referring to the data.

The transaction manager unit 315 furthermore requests that the transaction manager device 401 add the transaction ID to the snapshot that the transaction manager device 401 manages at the time of starting a transaction.

Moreover, the transaction manager unit 315 requests that the transaction manager device 401 delete the transaction ID from the snapshot at the time of transaction termination.

The cache updating unit 316 updates the cache data 321.

The cache updating unit 316 periodically checks the other nodes to confirm whether or not the data handled in the other nodes was updated.

The log manager unit 317 records update information of the transaction in the log 324. The update information is used to recover the database 323 to its latest condition when the update data is invalidated at the time of transaction rollback or when the distributed database system 101 goes down.

The communication unit 318 is a communication interface to the other nodes. Communication is made through the communication unit 318 to update data handled by the other nodes or to confirm whether or not the data in the other nodes was updated during regular cache checks performed by the cache updating unit 316.

The cache 319 is storage means storing data used by the node 301-1. It is desirable that the cache 319 have a faster read/write speed than the storage unit 320. The cache 319 is Random Access Memory (RAM), for example.

The cache 319 stores the cache data 321 and the locator 322. It should be noted that the cache data 321 corresponds to the cache data 304-1 in FIG. 4. The cache 319 also stores a snapshot and a timestamp that are described later.

The cache data 321 is data including the content of the database 323. The cache data 321 further includes at least a portion of the content of the database stored in the other nodes.

The locator 322 is information indicating which of the nodes handles each piece of data. In other words, it is information in which data and a node including a database storing the data are associated.

The storage unit 320 is storage means to store data used in the node 301-1. The storage unit 320 is a magnetic disk device, for example.

The storage unit 320 stores the database 323 and the log 324.

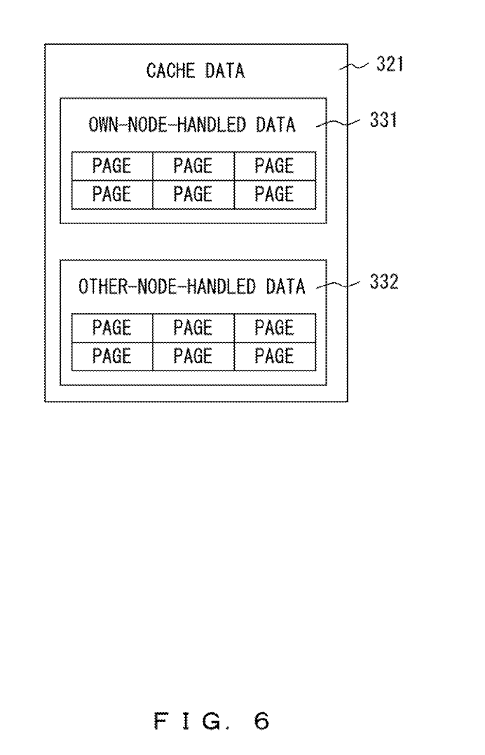

FIG. 6 is a diagram illustrating a configuration of the cache.

Here, the cache data in the node 301-1 is explained.

The cache data 321 includes own-node-handled data 331 and other-node-handled data 332.

The own-node-handled data 331 is data that is stored in the storage unit 320, or in other words it is data having the same content as the content of the database 323 in the node 301-1.

Since the database 323 consists of plural pages, the own-node-handled data 331 similarly consists of plural pages.

The own-node-handled data 331 is updated in synchronization with the updating of the database 323, and therefore is always the latest data.

The other-node-handled data 332 is data in which a part of or all of the content is the same as the content of the database stored in each storage unit of each of the other nodes.

However, the other-node-handled data 332 is updated out of synchronization with the updating of the database in other nodes. For that reason, the other-node-handled data 332 may not be the latest data. In other words, the other-node-handled data 332 and the content of the database stored in one of the other nodes can be different at a given point in time. Similarly to the own-node-handled data 331, the other-node-handled data 332 also consists of plural pages.

For example the other-node-handled data 332 in the node 301-1 is data in which a part of or all of the content is the same as the content of the database 305-2 or 305-3.

Next, the structure of the pages is explained.

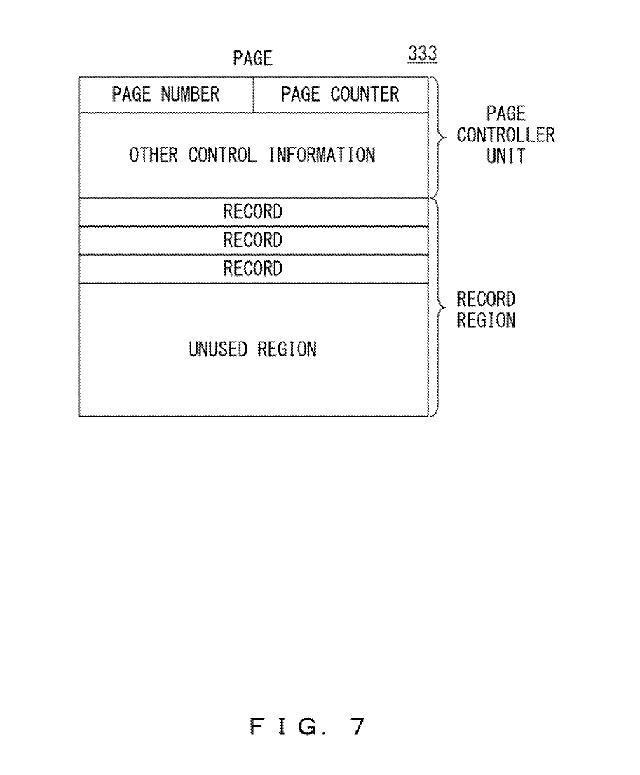

FIG. 7 is a diagram illustrating the detailed structure of a page.

A page 333 has a page controller and a record region.

The page controller includes a page number, a page counter, and other control information.

The page number is a unique value to identify pages.

The page counter indicates the number of times the page is updated, and is incremented every time the page is updated.

Other control information includes information such as a record position and its size and a page size.

The record region includes records and unused regions.

Each of the records is data of a single case.

The unused regions are regions in which no record is written.

Next, the structure of the record is explained.

The node 301 implements MVCC, and a single record consists of records of plural generations.

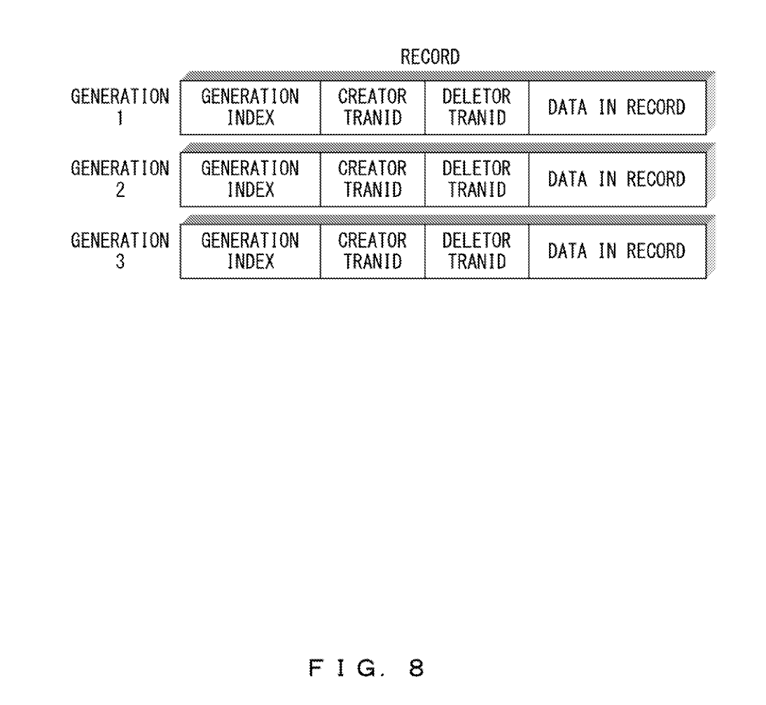

FIG. 8 is a diagram illustrating the structure of a record.

FIG. 8 illustrates a structure of a single record.

The record has a generation index, a creator TRANID, a deletor TRANID, and data, as items.

The generation index is a value indicating the generation of the record.

The creator TRANID is a value indicating a transaction in which the record of the generation is created.

The deletor TRANID is a value indicating a transaction in which the record of the generation is deleted.

The data is data in the record.

In FIG. 8, three generations of records are illustrated, and generation 1 is the oldest record and generation 3 is the latest record.

Next, the transaction manager device 401 is explained.

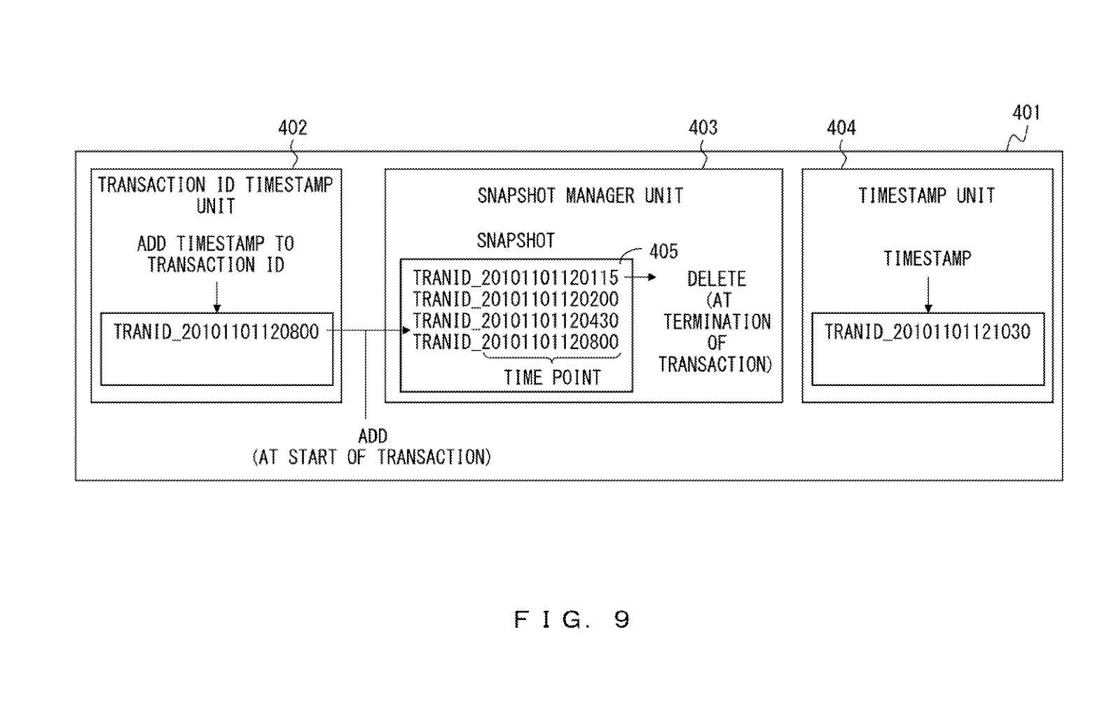

FIG. 9 is a diagram illustrating the configuration of the transaction manager device according to the embodiment.

The transaction manager device 401 includes a transaction ID timestamp unit 402, a snapshot manager unit 403, and a timestamp unit 404.

The transaction ID timestamp unit 402 adds timestamps transaction IDs sequentially in order of the start time of transactions. In this embodiment, a transaction ID is “TRANID_timestamp”. The time is a point in time at which the transaction ID timestamp unit 402 receives a request for time-stamping. Owing to “TRANID_timestamp” including a point in time in the transaction ID, which transaction has been started first can become clear by comparing the transaction IDs.

The snapshot manager unit 403 manages a snapshot 405.

The snapshot 405 is information indicating a list of transactions in execution. The snapshot 405 is stored in a storage unit (not illustrated in the drawing) in the snapshot manager unit 403 or in the transaction manager device 401.

In this embodiment, the snapshot 405 is a list of transaction IDs of the transactions in execution in the distributed database system 101. The snapshot manager unit 403 adds a transaction ID of a transaction to be started at the time of the transaction start to the snapshot 405, or deletes a transaction ID of a transaction terminated at the time of the transaction termination from the snapshot 405.

The timestamp unit 404 timestamps in response to requests from the nodes 301, and transmits the timestamp to the nodes 301. Since the timestamp is made in response to the requests from the nodes 301, the timestamp indicates a point in time at which a request is received.

In this embodiment, the timestamp unit 404 makes the timestamp so that data has the same format as the format of the transaction ID to which the transaction ID timestamp unit 402 timestamps. In other words, the timestamp is transmitted to the nodes in a form of “TRANID_timestamp”.

Because the timestamp and the transaction ID are in the same format, these can be compared to discover whether the time of the timestamp is earlier than the start of the transaction or the start of the transaction is earlier than the time of the timestamp.

Next, updating of cache data is explained.

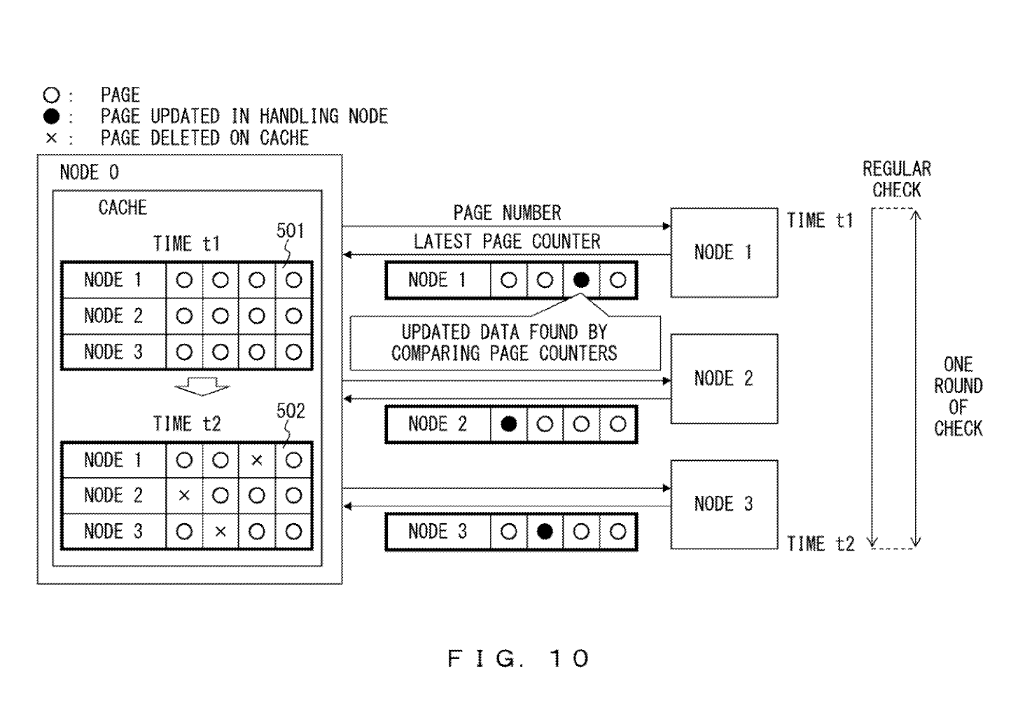

FIG. 10 is a diagram illustrating updating of cache data according to the embodiment.

A node in the present embodiment checks whether or not cache data is kept up to date by periodically checking the updating of databases in other nodes.

FIG. 10 illustrates updating of cache in a node 0.

In FIG. 10, an open circle represents a page, a black circle represents a page updated in a node handling the data of the page, and x represents a page deleted from cache.

Here, the node 0 checks updating of databases in other nodes, a node 1 through a node 3.

Other-node-handled data 501 in the node 0 at a time point t1 has four pages for each node of the node 1 through the node 3.

The node 0 sends a page number to the node 1. The node 1 transmits a page counter of the page corresponding to the received page number to the node 0.

The node 0 compares the received page counter with the page counter of the page in the other-node-handled data 501, and determines that the page has been updated when the page counters are different. Afterwards, pages with a different page counter than the received page counter are deleted. In FIG. 10, the third page from the left of node 1 in the other-node-handled data 501 is deleted.

The same processing is conducted in the pages of the node 2 and the node 3, and the first page from the left of node 2 and the second page from the left of node 3 in the other-node-handled data 501 are deleted. At a time point t2, checks in all of the other nodes are completed.

As a result, at the time point t2, the other-node-handled data is changed to the data illustrated as other-node-handled data 502.

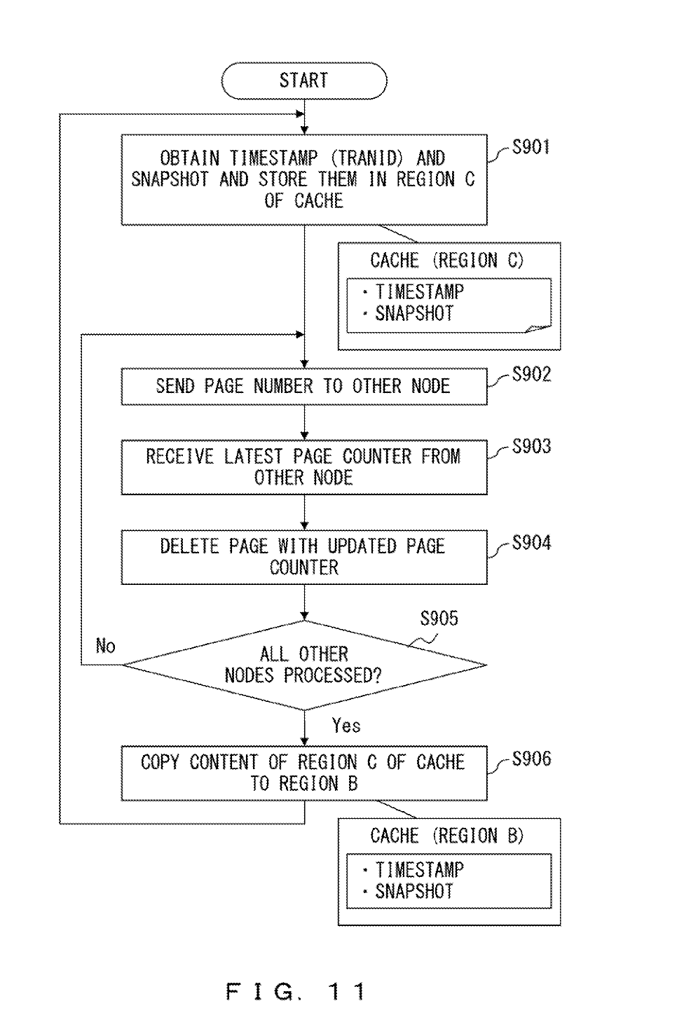

FIG. 11 is a flowchart of cache data update processing according to the present embodiment.

Here, the processing in the node 301-1 is explained.

In step S901, the cache updating unit 316 requests that the transaction manager device 401 send a timestamp and the snapshot 405. The cache updating unit 316 receives the timestamp and the snapshot from the transaction manager device 401, and stores them in a region C of the cache 319. As explained above, in the present embodiment, the format of the timestamp is the same as the format of the transaction ID.

In step S902, the cache updating unit 316 selects one of the other nodes that have not been selected, and sends a page number of the other-node-handled data handled by the selected node.

In step S903, the cache updating unit 316 receives a page counter from the node to which the page number is sent. The received page counter is the latest page counter.

In step S904, the cache updating unit 316 deletes any page in which the page counter was updated. In other words, the cache updating unit 316 compares the page counter of each page in other-node-handled data with the received page counter, and when the page counters are different, it deletes any page with a different page counter than the received page counter.

In step S905, the cache updating unit 316 determines whether or not all of the other nodes have been processed, or in other words, whether or not page numbers are sent to all of the other nodes. When all of the other nodes have been processed, the control proceeds to step S906, and when all of the other nodes have not been processed, the control returns to step S902.

In step S906, the cache updating unit 316 copies the content of the region C in the cache 319, or more specifically the timestamp and the snapshot 405, to a region B in the cache 319.

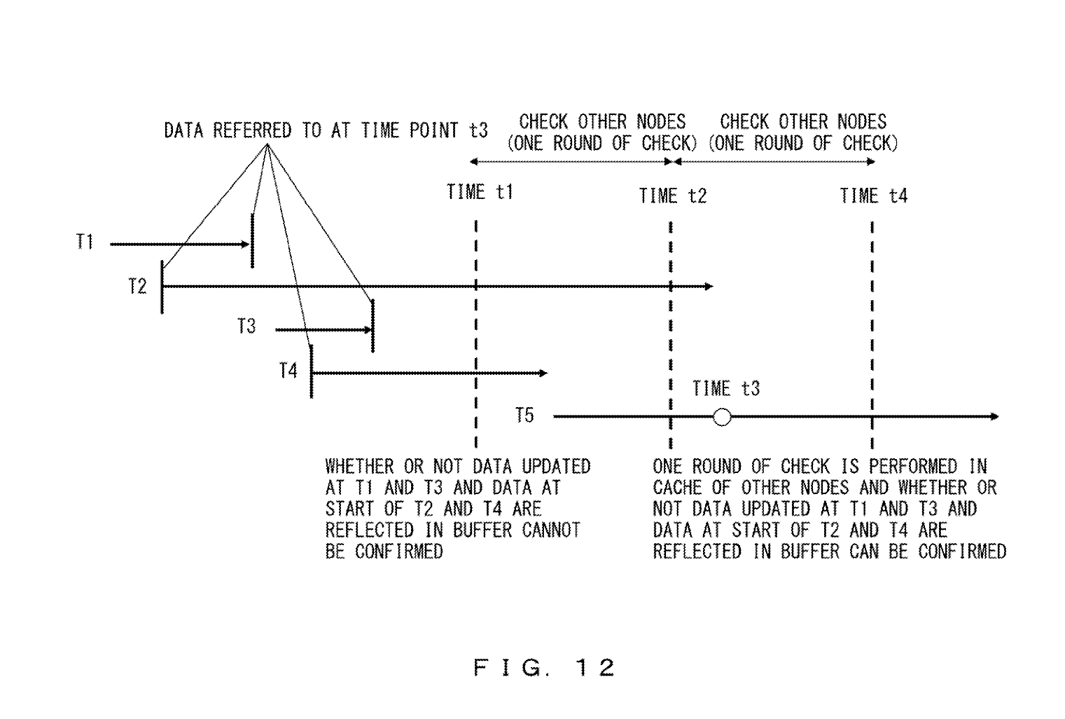

FIG. 12 is a diagram explaining data consistency according to the present embodiment.

In FIG. 12, the horizontal axis represents time, or more specifically the execution times of transactions T1 through T5.

Here, it is assumed that the time point t1<t2≦t3<t4.

The transactions T1 and T3 are committed before the time point t1. The transactions T2 and T4 are started before the time point t1.

The node performs periodical checking of other nodes to confirm whether or not data has been updated. In FIG. 12, one round of the checking is performed between the time points t1 and t2 and between the time points t2 and t4.

At the time point t1, whether or not the cache data reflects the data committed in the transactions T1 and T3 and data at the time of starting the transactions T2 and T4 (i.e., whether these pieces of data are the same as those in cache data) cannot be confirmed.

At the time point t2, since one round of checking has been performed in caches in other nodes, it becomes possible to determine whether or not the data referred to at the time point t3 reflects the data committed in the transactions T1 and T3 and whether or not the cache data reflects the data at the time of starting the transactions T2 and T4. As explained above, the pages updated in the other nodes are deleted from the cache data as a result of the cache update processing.

When data that is not reflected in the cache data, namely, data deleted from the cache data, is to be referred to, the node obtains the data from a node handling the data at the time point t3 and stores the data in the cache data. The obtained data is pages including the data to be referred to. After retrieving the pages, the node deletes data of generations that were committed at or after the time point t1 and reflects the data of each generation updated before the time point t1 in the cache data.

When the data is referred to at the time point t3, a snapshot at the time point t1 or a snapshot obtained at the time of receiving a record-referring request is used. The snapshots include the transaction IDs of the transactions T2 and T4.

Next, the selection processing of a snapshot used to identify the referred-to record is explained.

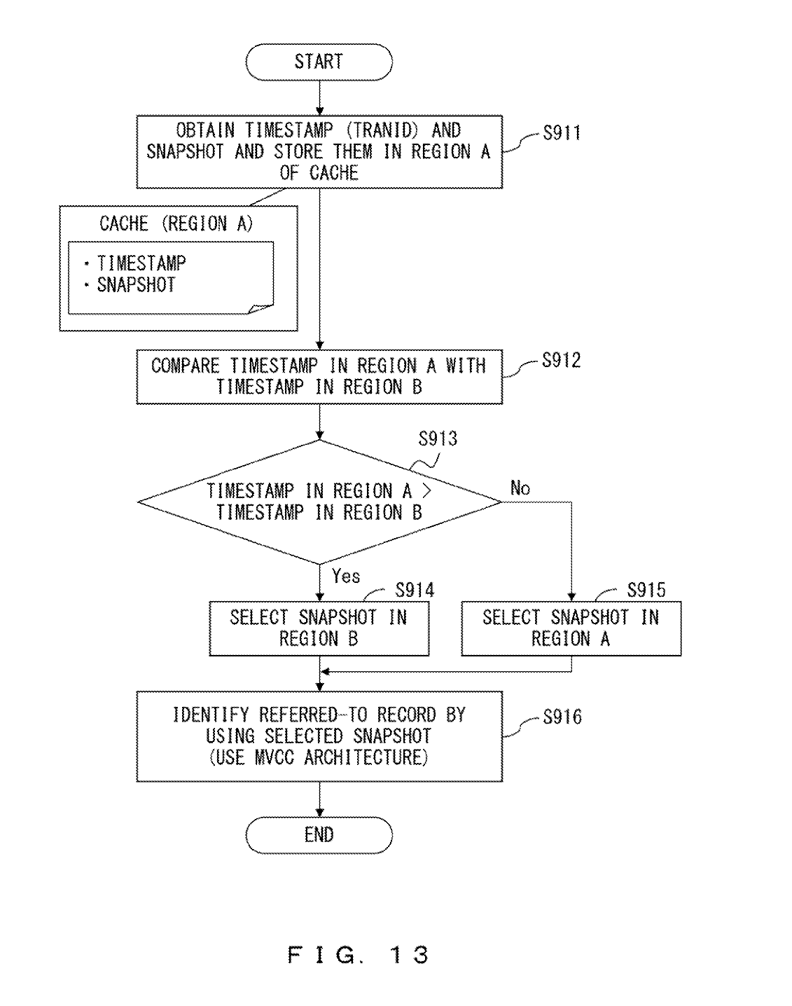

FIG. 13 is a flowchart of snapshot selection processing according to the embodiment.

Here, the processing in the node 301-1 is explained.

Firstly, the node 301-1, when receiving a record-referring request, determines whether or not the record is included in the own-node-handled data 331. If the record is included, the record is read out and a response is made. Whether or not the record is included in the own-node-handled data 331 is determined by using the locator 322. When the requested record is not included in the own-node-handled data 331, that is, when another node handles the data, whether or not the record is included in the other-node-handled data 332 is determined. When the record is not included in the other-node-handled data 332, pages including the record are obtained from another node handling the record and are reflected in the cache data 321 as stated in the explanation of FIG. 12.

In step S911, the transaction manager unit 315 requests that the transaction manager device 401 send a timestamp and a snapshot 405. The transaction manager unit 315 afterwards receives the timestamp and the snapshot from the transaction manager device 401 and stores them in a region A of the cache 319.

In step S912, the record operation unit 313 compares the timestamp in the region A with the timestamp in the region B.

In step S913, when the timestamp in the region A is more recent than that of the region B, the control proceeds to step S914, and when the timestamp in the region A is older, the control proceeds to step S915.

In step S914, the record operation unit 313 selects the snapshot in the region B.

In step S915, the record operation unit 313 selects the snapshot in the region A.

In step S916, the record operation unit 313 uses the selected snapshot to identify a record of a generation to be referred to (valid record) from among the records of plural generations. By referring to the identified record, the value of the record is transmitted to the requestor.

Next, the identification processing of the record to be referred to is explained.

As explained above, the node of the present embodiment implements MVCC, and each record stores values to identify a transaction that created the record and a transaction that deleted the record. The node determines whether a record is of a valid generation or of an invalid generation for a given transaction. This determination is referred to as satisfy processing.

In the satisfy processing, a record that conforms to the following rules is determined as a record of a valid generation.

The creator TRANID of a record:
is not a transaction ID (TRANID) in the snapshot, excepting own transaction ID; and
is not TRANID of a transaction started at or after the time when the snapshot is obtained, and
the deletor TRANID of the record:
is unset; or
is a TRANID included in the snapshot, excepting own transaction ID; or
is a TRANID of a transaction started at or after the time when the snapshot is obtained.

Here, own transaction ID is a transaction ID of a transaction to refer to a record.

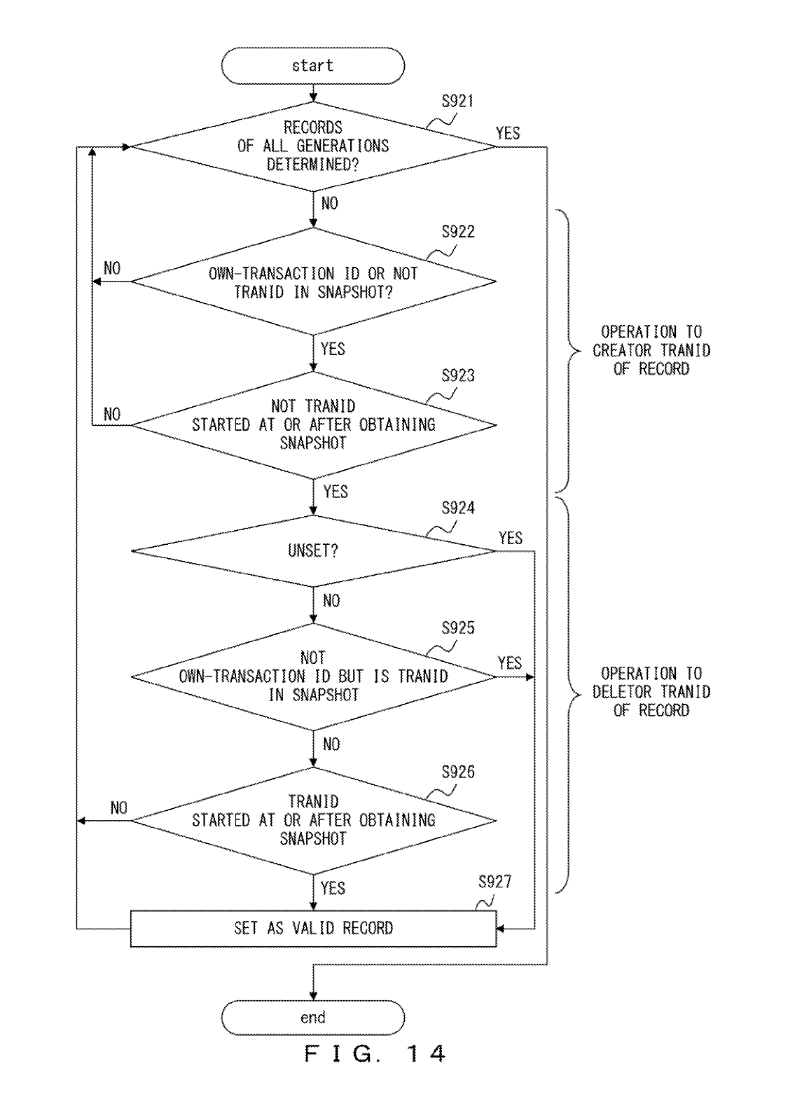

FIG. 14 is a flowchart of identification processing of a referred-to record according to the embodiment.

FIG. 14 illustrates details of processing to identify a record of a generation that was referred to in step S916.

In step S921, the record operation unit 313 determines whether or not records of all generations have been determined. When the records of all generations have been determined, the processing is terminated and when the records of all generations have not been determined, the record of the oldest generation is selected from among the records of undetermined generations, and the control proceeds to step S922. In the following steps, whether the selected record is of a valid generation or of an invalid generation is determined.

In step S922, the record operation unit 313 determines if the record creator TRANID of the record is its own transaction ID or not a TRANID in the snapshot or if it is a TRANID in the snapshot and not an own transaction ID. When the creator TRANID of the records either is the same as its own transaction ID or is not a TRANID in the snapshot, the control proceeds to step S922, and when the creator TRANID is a TRANID in the snapshot and is not the same as an own transaction ID, the control returns to step S921.

In step S923, the record operation unit 313 determines whether or not the creator TRANID of the record is a TRANID started at or after the time when the snapshot is obtained. When the creator TRANID of the record is not a TRANID started at or after the time when the snapshot is obtained, the control proceeds to step S924, and when it is a TRANID started at or after the time when the snapshot is obtained, the control returns to step S921. In the present embodiment, the determination of whether or not the creator TRANID is a TRANID started at or after the time when the snapshot is obtained is made by using the timestamp of the time when the snapshot is obtained.

In step S924, the record operation unit 313 determines whether or not the deletor TRANID of the record has been unset. When the deletor TRANID of the record is unset, the control proceeds to step S927, and when the deletor TRANID of the record is set, the control proceeds to step S925.

In step S925, the record operation unit 313 determines if the deletor TRANID of the record is a TRANID included in the snapshot and is not an own transaction ID or if it is an own transaction ID or is not included in the snapshot. When the deletor TRANID of the record is a TRANID included in the snapshot and is not an own transaction ID, the control proceeds to step S927, and when the deletor TRANID of the record either is an own transaction ID or is not a TRANID included in the snapshot, the control proceeds to step S926.

In step S926, the record operation unit 313 determines whether or not the deletor TRANID of the record is a TRANID started at or after the time when the snapshot is obtained. When the deletor TRANID of the record is a TRANID started at or after the time when the snapshot is obtained, the control proceeds to step S927. When the deletor TRANID of the record is not a TRANID started at or after the time that the snapshot is obtained, the control returns to step S921. In the present embodiment, a determination of whether to not a transaction ID is a TRANID of a transaction started after the snapshot is obtained is made by using a timestamp of the time when the snapshot is obtained.

In step S927, the record operation unit 313 sets the selected record of a generation as a valid record. It should be noted that valid records that were previously set become invalid when a new valid record is set.

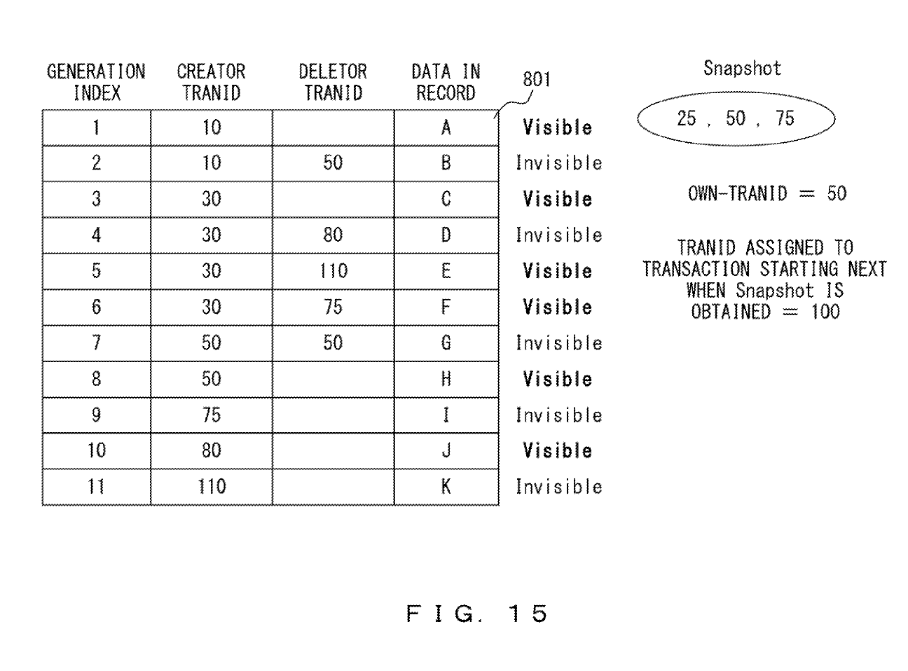

FIG. 15 is a diagram illustrating an example of the satisfy processing.

FIG. 15 illustrates a case in which the satisfy processing is performed on a record 801.

Here, the snapshots are “25, 50, 75”, and the own TRANID is 50, and the TRANID assigned to a transaction starting next at the time when the snapshot is obtained is 100.

When each generation of the records 801 is determined as valid or invalid based on the above-stated rules, the records with generation indexes 1, 3, 5, 6, 8, and 10 are determined to be valid (visible) and the records with generation indexes 2, 4, 7, 9, and 11 are determined to be invalid (invisible).

Here, the record with the largest generation index of the valid record from among all valid records, namely, the latest record of the valid records, eventually becomes the visible record. In FIG. 15, the record with the generation index 10 is the visible record that is a record to which a node refers.

According to the distributed database system of the present embodiment, consistent data can be referred to in a distributed database system in which a multisite update is performed and cache data is updated out of synchronization.

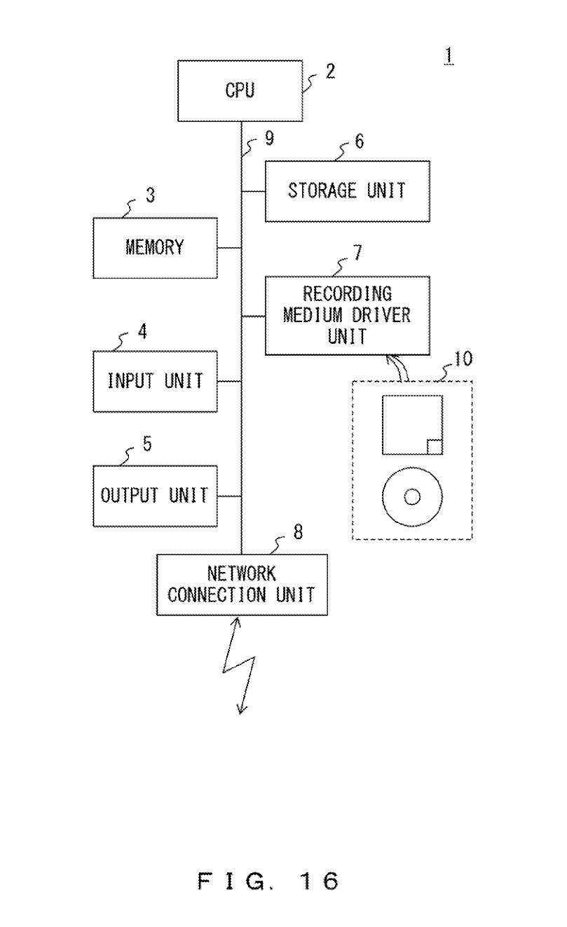

FIG. 16 is a diagram illustrating a configuration of an information processing device (computer).

Each of the nodes 301 of the present embodiment can be realized by the information processing device 1 illustrated in FIG. 16 as an example.

The information processing device 1 includes a CPU 2, a memory 3, an input unit 4, an output unit 5, a storage unit 6, a recording medium driver unit 7, and a network connection unit 8, and each of these components are connected to one another by a bus 9.

The CPU 2 is a central processing unit that controls the entire information processing device 1. The CPU 2 corresponds to the receiver unit 311, the data operation unit 312, the record operation unit 313, the cache manager unit 314, the transaction manager unit 315, the cache updating unit 316, and the log manager unit 317.

The memory 3 is a memory such as Read Only Memory (ROM) and Random Access Memory (RAM) that temporarily stores programs and data stored in the storage unit 6 (or a portable recording medium 10). The memory 3 corresponds to the cache 319. The CPU 2 executes various kinds of the above-described processing by executing a program by using the memory 3.

In such a case, program codes themselves readout from the portable recording medium 10 etc. realize the functions of the present embodiment.

The input unit 4 is a device such as a keyboard, a mouse, or a touch panel, as examples.

The output unit 5 is a device such as a display or a printer, as examples.

The storage unit 6 is a device such as a magnetic disk device, an optical disk device, or a tape device, for example. The information processing device 1 stores the above-described programs and data in the storage unit 6, and reads out the programs and data, when needed, to the memory 3 for use.

The storage unit 6 corresponds to the storage unit 320.

The recording medium drive unit 7 drives the portable recording medium 10 and accesses the recorded content. A computer-readable recording medium such as a memory card, a flexible disk, a Compact Disk Read Only Memory (CD-ROM), an optical disk, and a magneto optical disk, is used as the portable recording medium. A user stores the above-described programs and data in the portable recording medium 10 and uses the programs and data when needed by reading out the programs and data in the memory 3.

The network connection unit 8 is connected to a communication network such as a LAN to exchange data involved with the communication. The network connection unit corresponds to the communication unit 318.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment (s) of the present invention has (have) been described in detail, it should be understood that the various changes, substitutions, and alterations could be made hereto without departing from the spirit and scope of the invention.

What is claimed is:

1. A non-transitory computer-readable recording medium for recording a data management program to cause a computer to execute a process, the process comprising:
within a prescribed time period after a record stored in another computer is updated, storing the updated record so that the record before the updating and the updated record are stored in a storage unit; and
by a point in time at which the prescribed time period has passed starting from a second point in time that is a point in time from which the prescribed time period has passed starting from a first point in time, receiving a reference request for the record, and when a transaction to perform the updating in the another computer is present at the first point in time, transmitting the record before the updating that is stored in the storage unit to a requestor of the reference request.

2. The recording medium of claim 1, wherein the process further comprises receiving the reference request, and when the transaction to perform the updating is not present at the first point in time, transmitting the updated record stored in the storage unit to the requestor of the reference request.

3. A node comprising:
a cache to store cache data that is at least a portion of data stored in another node, a first transaction list indicating a list of transactions executed in a distributed database system, and a first point in time indicating a point in time at which a request for the first transaction list is received by a transaction manager device; and
a processor, when a reference request of records of a plurality of generations included in the cache data is received, to receive and to store in the cache a second transaction list and a second point in time indicating a point in time at which the transaction manager device received a request for the second transaction list, to compare the first point in time with the second point in time, to select either the first transaction list or the second transaction list as a third transaction list by using a result of the comparing, and to identify a record of a generation to be referred to from among the records of the plurality of generations by using the third transaction list.

4. The node of claim 3 wherein
the node periodically receives the first transaction list and the first point in time from the transaction manager device.

5. The node of claim 3 wherein
the node determines whether or not data stored in the another node corresponding to the cache data is updated, and deletes the cache data when the data is updated.

6. The node of claim 5 wherein
the node receives a fourth transaction list and a fourth point in time indicating a point in time at which a transaction manager device received a request from the fourth transaction list before the processing of determining whether or not the data stored in the another node corresponding to the cache data has been updated, and stores in the cache the fourth transaction list and the fourth point in time as the first transaction list and the first point in time, respectively, after termination of the determining processing.

7. A distributed database system comprising:
a transaction manager device including:
a first processor to manage a transaction list indicating a list of transactions in execution in the distributed database system, and to transmit to a node a point in time at which a request from the node is received; and
a plurality of nodes, wherein each of the plurality of nodes includes:
a cache to store cache data that is at least a portion of data stored in another node, a first transaction list indicating a list of transactions executed in a distributed database system, and a first point in time indicating a point in time at which a request for the first transaction list is received by a transaction manager device; and
a second processor, when a reference request of records of a plurality of generations included in the cache data is received, to receive and to store in the cache a second transaction list and a second point in time indicating a point in time at which the transaction manager device received a request for the second transaction list, to compare the first point in time with the second point in time, to select either the first transaction list or the second transaction list as a third transaction list by using a result of the comparing, and to identify a record of a generation to be referred to from among the records of the plurality of generations by using the third transaction list.
